(19) United States
(12) Patent Application Publication
(10) Pub. No.: US 2008/0116702 A1
(43) Pub. Date: May 22, 2008

(54) Vehicle side under ride guard

(76) Inventors: Bruce E. Enz, Avon, IN (US); John E. Tomassoni, Annapolis, MD (US); Angela Trego, Sandy, UT (US)

Correspondence Address: TROP PRUNER & HU, PC, 1616 S. VOSS ROAD, SUITE 750, HOUSTON, TX, 77057-2631, US

(21) Appl. No.: 11/601,453

(22) Filed: Nov. 17, 2006

(51) Int. Cl. B60R 19/42

(52) U.S. Cl. 293/128

(57) ABSTRACT

A side under ride guard for a large vehicle having a trailer portion with a relatively high ground clearance is provided. The trailer portion has a front, a rear, and opposing side edges extending between the front and the rear. The side under ride guard attaches to the trailer portion and is positioned below the side edge of the trailer portion a distance sufficient to obstruct progress of a passenger vehicle under the side edge of the trailer. The side under ride guard further is positioned relative to the side edge of the trailer so as to prevent intrusion of the side edge into the passenger vehicle occupant compartment as well as to minimize the regions of contact between the passenger vehicle and the side under ride guard itself.

### BACKGROUND

Today's roads are shared by many types of vehicles, including passenger vehicles and large commercial vehicles having a trailer portion. As compared to passenger vehicles, large commercial vehicles have a relatively high ground clearance, which presents the opportunity for a passenger vehicle to run under the body of the large vehicle in the event of a collision. In such types of collisions, there is a risk that the trailer body will penetrate the passenger car occupant compartment, which may result in serious injury to the vehicle's occupants. Additionally, a vehicle that underruns the body of the trailer may collide with trailer underbelly components, thus resulting in further injury to the passenger vehicle occupants, as well as extensive damage to the commercial vehicle.

In the past, various solutions have been offered for preventing passenger vehicles from running under the body of a vehicle with high ground clearance. Such solutions have typically addressed situations in which the passenger vehicle impacts the rear of the other vehicle. Other solutions have provided underrun protection in the event of head-on collisions. Although there are known guard devices that extend from the side of a large vehicle, these devices have been designed only to reduce the risk that a person or vehicle may be dragged under the large vehicle's rear wheels and do not take into account the injury or damage that may be imparted to the person or vehicle by the guard device itself. In other words, these devices do not offer a robust solution that both substantially reduces the risk of side underrun and minimizes the injury that may result from collision with the guard device itself.

### BRIEF DESCRIPTION OF THE DRAWINGS

FIG. 1 shows a large vehicle having a trailer portion, each side of which is equipped with an exemplary embodiment of a side under ride guard;

FIG. 2 is a perspective view of an exemplary embodiment of a side under ride guard;

FIG. 3 illustrates an exemplary collision of a passenger vehicle with a side under ride guard that is attached to a vehicle, such as the vehicle shown in FIG. 1;

FIG. 4 is a partial top plan view of the side under ride guard of FIG. 2;

FIG. 5 is a side view of the side under ride guard of FIG. 2;

FIG. 6 is a close up oblique view of a portion of the underside of the trailer portion of the vehicle of FIG. 1;

FIG. 7 is a perspective view of another exemplary embodiment of a side under ride guard;

FIG. 8 is a perspective view of yet another exemplary embodiment of a side under ride guard;

FIG. 9 is a perspective view of still another exemplary embodiment of a side under ride guard;

FIG. 10 is a side view of the embodiment of the side under ride guard illustrated in FIG. 9, showing the side under ride guard attached to the underside of a vehicle; and

FIG. 11 is a perspective view of yet another exemplary embodiment of a side under ride guard.

### DETAILED DESCRIPTION

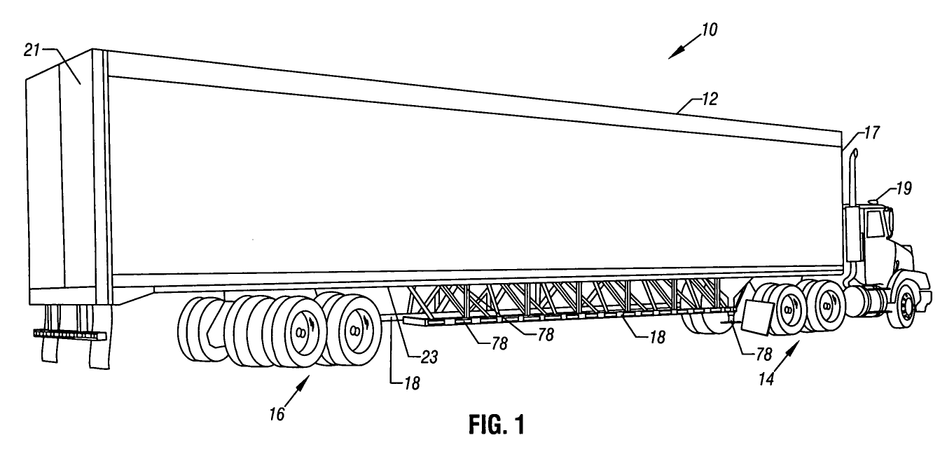

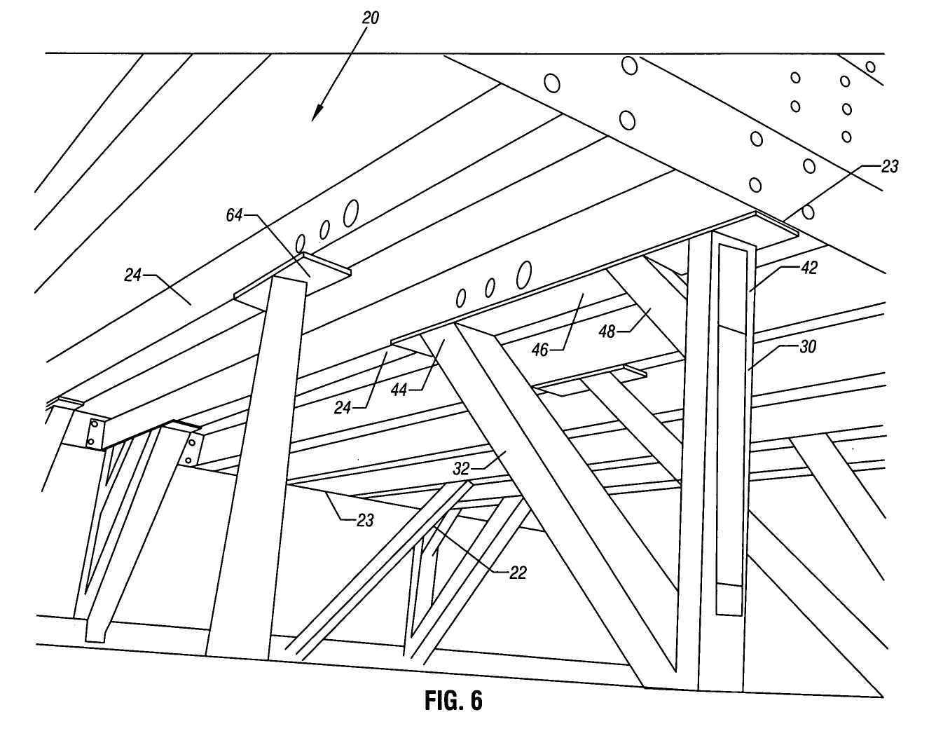

FIG. 1 illustrates a large vehicle 10 having a cab or tractor portion 19 and a trailer portion 12 with relatively high ground clearance. The trailer portion 12 includes a body frame 20 (see FIG. 6) which is carried on a front set of wheels 14 and a rear set of wheels 16. In the embodiment shown in FIG. 1, the front set of wheels 14 are the wheels that are closest to a front 17 of the trailer portion 12, and the rear set of wheels 16 are those wheels which are closest to a rear 21 of the trailer portion 12. Also in the embodiment shown in FIG. 1, trailer portion 12 is detachable from tractor portion 19, and front set of wheels 14 are carried by the tractor portion 19. In other embodiments, vehicle 10 may be a straight truck (i.e., the trailer portion is not detachable from the cab) and front set of wheels 14 may be the driving wheels under cab 19. FIG. 1 further shows a pair of side under ride guards 18 attached to trailer portion 12. Each side under ride guard 18 is positioned below a respective side edge 23 of trailer portion 12 and extends in the open space between front set of wheels 14 and rear set of wheels 16.

Throughout the following description, unless otherwise specifically noted, the term “inboard” refers to a portion of an element that faces toward a center of vehicle 10 and the term “inward” refers to a direction that extends towards the center of vehicle 10. Likewise, unless otherwise specifically noted, “outboard” refers to a portion of an element that faces away from the center of vehicle 10 and “outward” refers to a direction that extends away from the center of vehicle 10.

With reference again to the embodiment shown in FIG. 1, and as can better be seen in FIG. 6, trailer portion 12 of vehicle 10 includes a body frame 20 having a plurality of cross members 24 which extend between opposing side edges 23 at spaced apart intervals. Typically, cross members 24 are spaced at intervals of 12 inches, 18 inches or 24 inches. However, side under ride guard 18 may be adapted for use with body frames having different configurations (such as frames which also include longitudinal side members) and/or different cross member spacings.

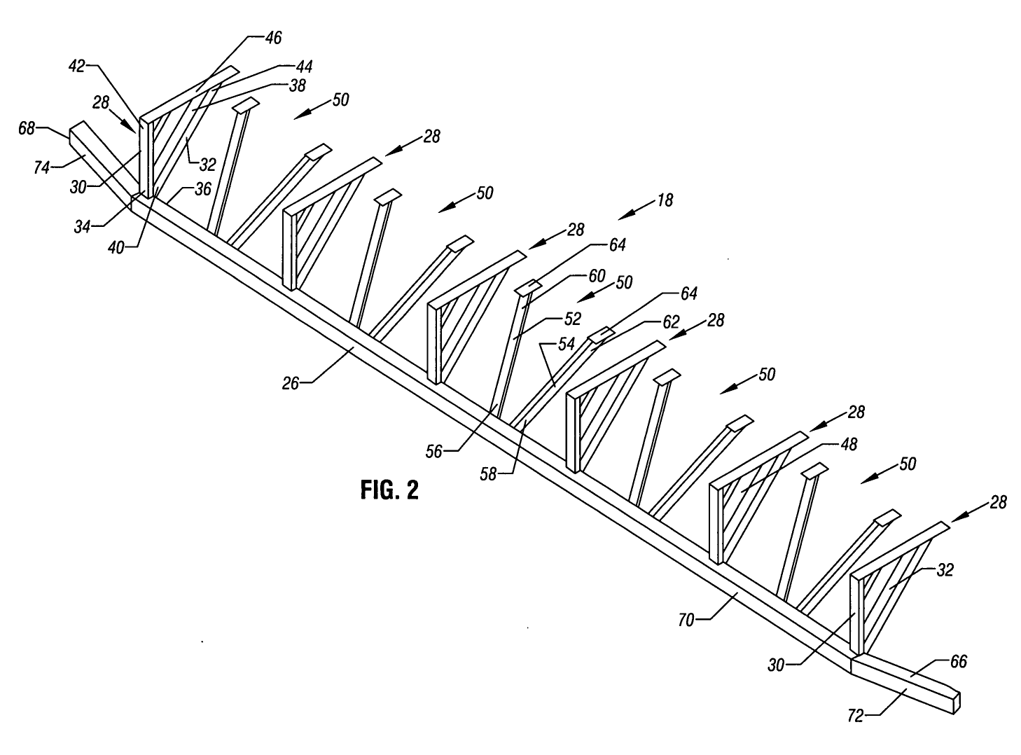

Referring now to FIG. 2, one exemplary embodiment of a side under ride guard 18 is illustrated. In this embodiment, side under ride guard 18 includes an elongate member 26 and a plurality of support members 28. In the embodiment shown, support members 28 are spaced at approximately 4-foot intervals such that members 28 may be conveniently attached to cross members 24 of a body frame 20 that has a cross member spacing of either 12, 18, or 24 inches. However, support members 28 may be positioned at other intervals suitable for attachment to a particular trailer configuration and/or to satisfy the structural requirements of a particular trailer configuration. Support members 28 also may be attached to structural elements of frame 20 other than cross members 20.

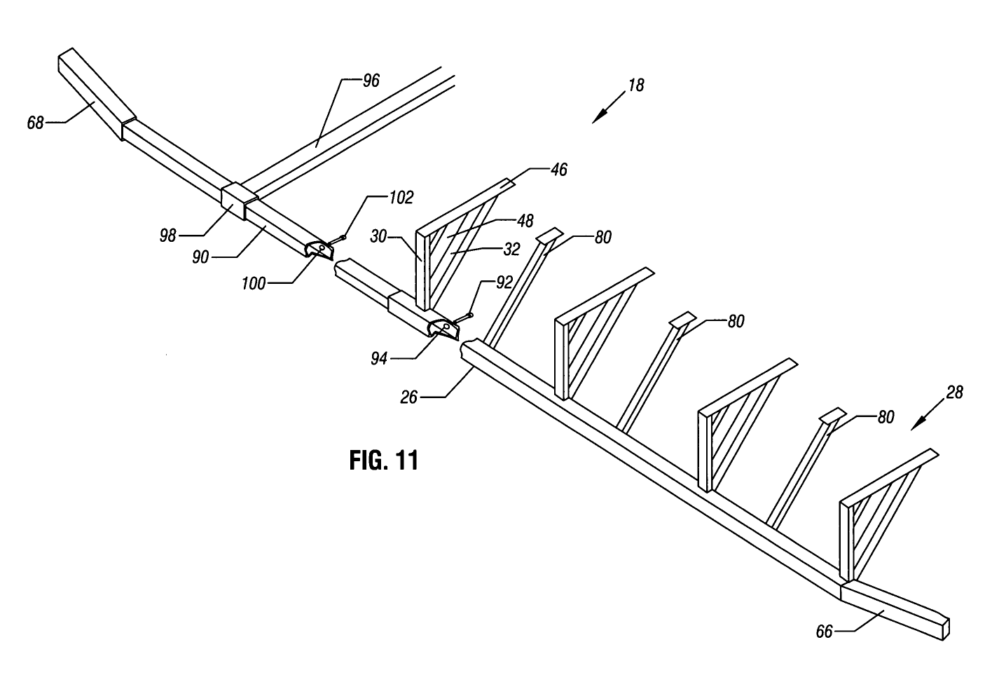

Each support member 28 includes an upright strut 30 and an angled strut 32. As shown in FIGS. 2, 4 and 5, each upright strut 30 has a lower end 34 that is attached proximate a top inboard edge 36 of the elongate member 26. In yet other embodiments, such as the embodiment illustrated in FIG. 11, upright strut 30 may be inset from the inboard edge 36 of elongate member 26, such as by a distance of approximately 4 to 6 inches. In such an embodiment, lower end 34 of upright strut 30 may be attached to a top surface 38 of angled strut 32.

With reference still to FIGS. 2, 4 and 5, a lower end 40 of angled strut 32 is attached to elongate member 26 proximate inboard edge 36 such that an angle A of approximately 45 degrees is formed therebetween. However, angle A at the point of attachment may be more or less than 45 degrees depending on the particular application in which side under ride guard 18 will be used. Upper ends 42 and 44 of upright strut 30 and angled strut 32, respectively, are configured for attachment to body frame 20 of trailer portion 12. For example, as shown in the embodiments illustrated in FIGS. 2 and 6, upper ends 42 and 44 are attached to a strap 46, which in turn is attached to the underside of body frame 20, such as to a cross member 24 by welding or using a fastener (e.g., a bolt, pin, etc.). In other embodiments, strap 46 may be omitted, and upper ends 42 and 44 may be fitted into a sleeve structure extending from the underside of body frame 20. In such an embodiment, upper ends 42 and 44 may be attached to body frame 20 either by welding, bolting or pinning once the upper ends 42 and 44 are positioned in the sleeve structure. Alternatively, upper ends 42 and 44 may be attached directly to the body frame 20 by a suitable bolt or pin arrangement.

Each support member 28 further includes an angled gusset 48. Angled gusset 48 is attached to the inboard side of upright strut 30 and the underside of strap 46. While the angled gusset 48 may provide additional strength to support member 28, angled gusset 48 may not be used in all embodiments. For instance, in embodiments of side under ride guard 18 in which upright struts 30 are inset from elongate member 26, angled gusset 48 may be omitted.

Referring again to FIG. 6, it can be seen that support member 28 is attached to body frame 20 of trailer portion 12 at both an inward region of body frame 20 and an outward region of body frame 20. The outward region is that region of body frame 20 which is generally proximate each of opposing side edges 23. The inward region is that region of the body frame 20 that encompasses the region between opposing side edges 23. For instance, the inward region may encompass the central half to two-thirds portion of body frame 20.

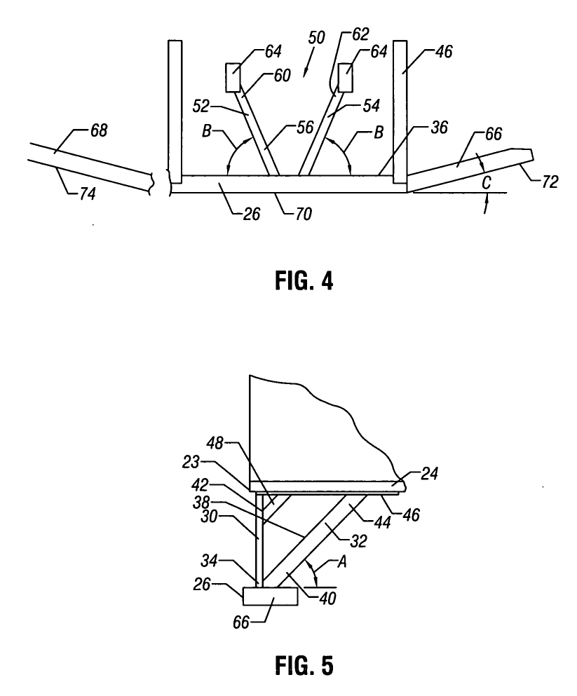

Returning to FIG. 2, side under ride guard 18 further includes a plurality of V bar struts 50. Each V bar strut 50 is attached at its lower end proximate the inboard edge 36 of elongate member 26. The upper end of each V bar strut 50 is attached to trailer portion 12 at the inward region of body frame 20. In the embodiment illustrated in FIG. 2, each V bar strut 50 includes a pair of angled struts 52 and 54 which are angled towards one another at the point of attachment to elongate member 26. Lower ends 56 and 58 of angled bars 52 and 54, respectively, may abut each other at the point where they attach to elongate member 26. Alternatively, ends 56 and 58 may be spaced apart up to a distance of approximately 6 inches. An angle B formed between lower ends 56 and 58 and elongate member 26 at the point of attachment may vary depending on the spacing between lower ends 56 and 58 and the manner in which upper ends 60 and 62 of bars 52 and 54 attach to trailer portion 12. In the embodiment shown in FIG. 4, angle B is approximately 60 degrees.

Upper ends 60 and 62 each are attached to a strap 64. As shown in FIG. 6, straps 64 may be used to attach each V bar strut 50 to body frame 20 at the inward region, such as by welding or fastening straps 64 to the underside of two cross members 24. In other embodiments, straps 64 may be omitted and V bar strut 50 may be attached to the body frame 20 by inserting upper ends 60 and 62 into corresponding sleeve portions extending from the underside of body frame 20 in the inward region. Upper ends 60 and 62 may be welded to such sleeve portions or may be fastened to the sleeve portions by a bolt or pin arrangement.

Referring again to FIG. 2, elongate member 26 includes angularly extending opposing ends 66 and 68. As can be seen in FIGS. 2 and 4, ends 66 and 68 extend angularly inward from the outboard side 70 of elongate member 26 such that an angle C between outboard side 70 of elongate member 26 and outboard sides 72 and 74 of ends 66 and 68, respectively, is in the range of approximately 15 to 30 degrees. Thus, when side under ride guard 18 is attached to the trailer portion 12, ends 66 and 68 extend inwardly and under opposing side edges 23. By angling ends 66 and 68 in this manner, a passenger vehicle that collides with trailer portion 12 at a shallow angle may not be speared by the ends of side under ride guards 18. Ends 66 and 68 may be separate pieces that are attached to elongate member 26. Alternatively, ends 66 and 68 may be an integral part of elongate member 26. Other configurations of ends 66 and 68 are contemplated that also may reduce the risk that ends 66 and 68 will penetrate or otherwise exacerbate the damage that may occur to vehicle 76 in the event of a collision.

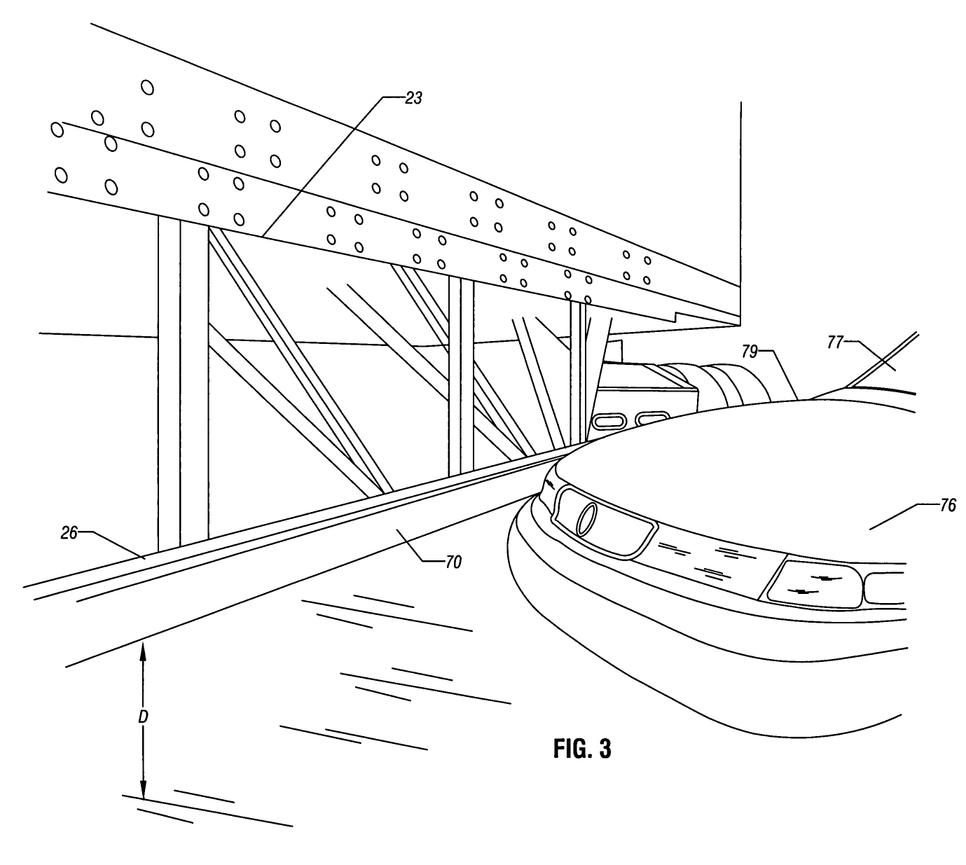

Referring now to FIG. 3, an exemplary collision of a passenger vehicle 76 with side under ride guard 18 is shown. Side under ride guard 18 extends below the body frame 20 of trailer portion 12 a distance D sufficient to obstruct progress of vehicle 76 under side edge 23 of trailer portion 12. Distance D may be selected based on trailer 12 and collision vehicle specifics. In the embodiment shown, the distance D between the underside of elongate member 26 and the ground is approximately 22 inches, and may be within a range of approximately 20 to 23 inches when trailer portion 12 is fully loaded, such that elongate member 26 of side under ride guard 18 interacts with the body of passenger vehicle 76 rather than with the vehicle's occupant compartment 77 (which is in the region above the vehicle belt line 79). In addition, as can be seen in FIG. 5, outboard side 70 of elongate member 26 lies substantially in the same plane as side edge 23 of trailer 12 so that side edge 23 does not intrude into occupant compartment 77. However, outboard side 70 may be positioned slightly inward or outward of side edge 23 provided that such positioning obstructs progress of vehicle 76 under side edge 23 as well as prevents intrusion of side edge 23 into the occupant compartment 77. Side under ride guard 18 also may be configured such that elongate member 26 captures or traps a portion of the body of passenger vehicle 76, such as the bumper portion, when passenger vehicle 76 collides with side under ride guard 18 at certain speeds, such as speeds greater than 30 miles per hour. Such a configuration may prevent redirection of passenger vehicle 76 off of side under ride guard 18 and subsequent collisions with other objects or vehicles.

In the event of a collision between another vehicle and side under ride guard 18 (such as the collision shown in FIG. 3), the force resulting from the collision generally is distributed along elongate member 26 to each of support members 28, as well as to V bar struts 50. Angled strut 32 of support members 28 and V bar struts 50 distribute at least a portion of the force resulting from the collision to cross members 24 of trailer body frame 20. The distribution of the force in this manner minimizes or prevents damage to body frame 20 of trailer portion 12.

Other embodiments of side under ride guard 18 may incorporate energy absorbing elements. For instance, each angled strut 32 of support members 28 may be provided with a crumple zone. A crumple zone may be implemented, for instance, by notching angled strut 32 in appropriate regions, drilling holes through angled strut 32 in appropriate regions, or fabricating angled strut 28 from a light gauge material such as a metal that is of a lighter gauge than the metal from which elongate member 26 is made. By providing a crumple zone, angled strut 28 may fold in the event of a collision, and thereby absorb at least a portion of the force resulting from the impact between passenger vehicle 76 and side under ride guard 18. V bar struts 50 may also be provided with crumple zones in a similar manner. Alternatively, side under ride guard 18 may incorporate resilient elements that also are positioned and configured to absorb a portion of the force from the collision.

In the embodiment shown in FIG. 1, side under ride guard 18 extends between front set of wheels 14 and rear set of wheels 16 such that a gap of no less than approximately 6 inches and no more than approximately 30 inches is left between the free end of end 68 and the closest tread face of the tires on rear set of wheels 16. Front end 66 of side under ride guard 18 is attached to a support stand 78 of trailer portion 12, such as by welding or bolting the free end of front end piece 66 to trailer support stand 78. For vehicles which do not include trailer support stand 78, the free end of end 66 may extend no closer than approximately 6 inches and no further than approximately 30 inches from the closest structural element which defines the front limit of the open space under side edge 23 of trailer portion 12. For instance, the front limit of the open space may be defined the tread face of the trailer tires on front wheel set 14 or may be the steps or running boards under the cab of a straight truck.

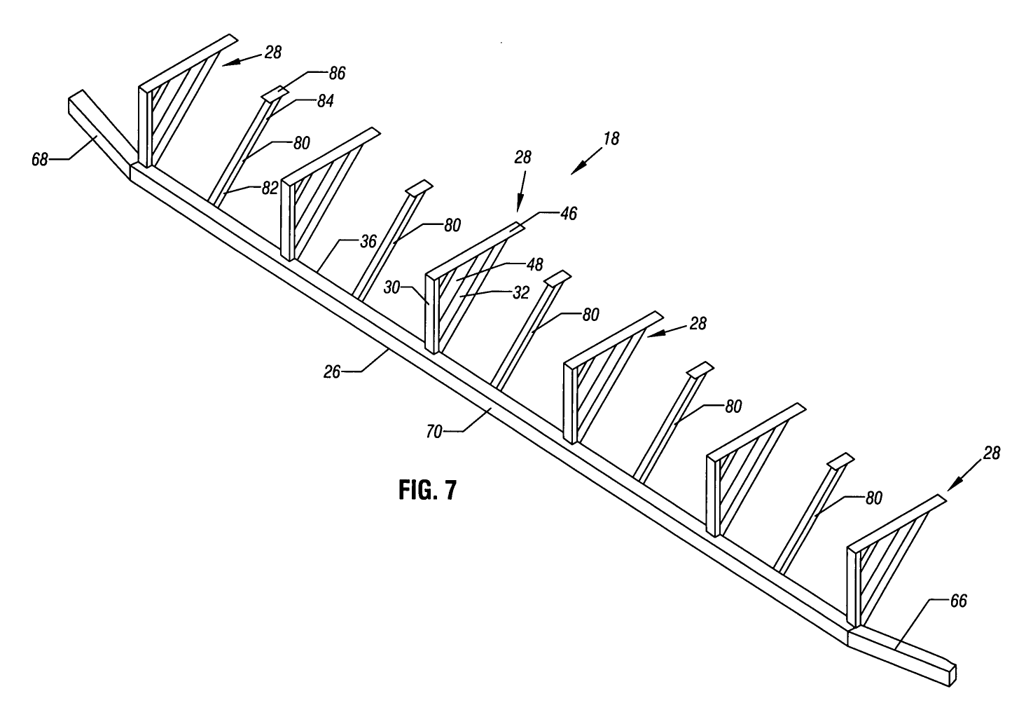

Turning now to FIG. 7, it illustrates another embodiment of a side under ride guard 18. In this embodiment, side under ride guard 18 includes elongate member 26 with angularly extending ends 66 and 68, and support members 28. V bar struts 50 are replaced with angled members 80 having a lower end 82 attached proximate inboard side edge 36 of elongate member 26. An upper end 84 of angled member 80 is attached to a strap 86. Strap 86 may be attached to the underside of trailer portion 12, such as by welding or fastening strap 86 to a cross member 24 at the inward region of body frame 20. In other embodiments, strap 86 may be omitted, and end 84 of angled member 80 may be attached to body frame 20 by other means, such as by fitting end 84 into a sleeve structure protruding from the underside of body frame 20. End 84 may be attached to such a sleeved structure by welding or using a fastener to attach end 84 to the sleeved structure. In the embodiment shown in FIG. 7, angled member 80 is attached to elongate member 26 such that an angle of approximately 45 degrees is formed between the elongate member 26 and the angled member 80. In other embodiments, the angle formed between elongate member 26 and angled member 80 may be an acute angle or an obtuse angle.

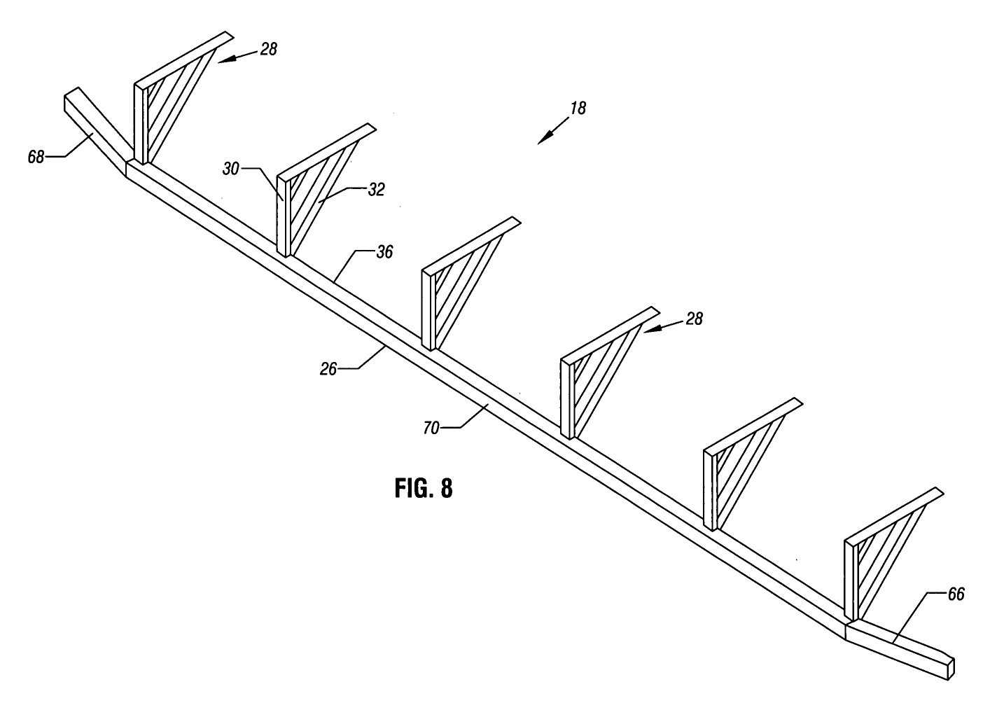

FIG. 8 illustrates yet another embodiment of a side under ride guard 18. In this embodiment, side under ride guard 18 includes elongate member 26 and support members 28. Each of support members 28 includes upright member 30 and angled member 32 which attach side under ride guard 18 to trailer portion 12 at outward and inward regions of body frame 20, as discussed above. The embodiment of side under ride guard 18 illustrated in FIG. 8 may be used in applications in which it is desirable to minimize the weight of side under ride guard 18. Further, the portions of elongate member 26 which extend between support members 28 may be configured to crumple or otherwise absorb a portion of the energy resulting from a collision.

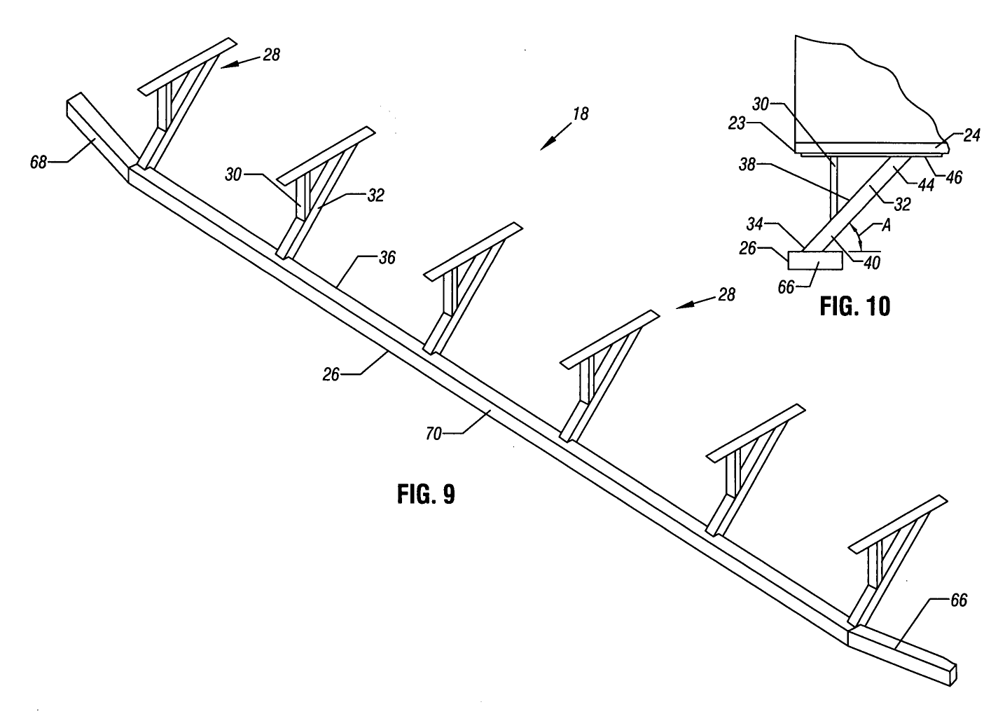

FIG. 9 illustrates an embodiment of side under ride guard 18 in which upright members 30 are spaced inwardly of elongate member 26. In this embodiment, when side under ride guard 18 is attached to trailer portion 12, elongate member 26 is substantially aligned in the same plane as side edge 23, and each upright member 30 is inset or positioned inwardly of side edges 23 and elongate member 26. Insetting upright members 26 in this manner substantially restricts contact between a vehicle 79 and side under ride guard 18 to interaction between vehicle beltline 79 and elongate member 26. Thus, the inset may reduce the risk that either an occupant of vehicle 76 or any portion of vehicle 76 above beltline 79 will contact any portion of side under ride guard 18. In the embodiment shown, upright member 30 is inset from elongate member 26 in the range of approximately 4 to 6 inches.

In the various embodiments of side under ride guard 18 illustrated in the figures, elongate member 26 and ends 66 and 68 may be made from 4 inch square steel tube or other structural configurations. If ends 66 and 68 are separate pieces, they may be attached to elongate member 26 by welding, bolting, pinning or other means. With respect to support members 28, upright member 30 may be made from 3 inch by 1½ inch steel C channel. Alternatively, particularly in embodiments in which upright member 30 is attached to angled member 32 spaced inwardly from elongate member 26, upright member 30 may be made from 2 inch square steel tube. In either embodiment, angled member 32 may be made from 3 inch square steel tube. Support members 28 are attached to elongate member 26 at spaced apart locations that are compatible with the spacing of cross members 24 of the particular trailer portion 12 with which side under ride guard 18 will be used. V bar struts 50 and angled struts 80 may be made from square steel tube or C channel steel bars and may further include crumple zones or resilient elements, as discussed above. Support members 28, V bar struts 50 and angled members 80 all may be attached to elongate member 26 by welding, bolting, pinning or other suitable means for secure attachment to member 26.

In the embodiments presented thus far, side under ride guard 18 has been described as being used with vehicles 10 having a fixed length trailer portion 12, such as an 18-wheel tractor trailer or a straight truck. However, it should be understood that side under ride guard 18 may be used with other types of vehicles having a high ground clearance as compared with a passenger vehicle.

For instance, it is envisioned that the various embodiments of side under ride guard 18 shown in FIGS. 2 and 7-9 may be adapted for use with vehicles 10 having a trailer portion 12 with an adjustable rear end in which the spacing between the front set of wheels 14 and the rear set of wheels 16 can be extended. In such applications, side under ride guard 18 may be configured with an extension portion. For example, with reference to FIG. 11, end 68 may be attached to an extension member 90 which fits inside of elongate member 26. The length of side under ride guard 18 can thus be extended by disconnecting end 68 from elongate member 26 and sliding out extension member 90 towards rear set of wheels 16 until a desired overall length of side under ride guard 18 is achieved. The desired length may then be maintained by attaching extension member 90 to elongate member 26, such as with a bolt or pin 92 inserted through an aperture 94.

Additional support members may be attached to extension 90 as desired to attach extension 90 to trailer portion 12. For instance, as shown in FIG. 11, one end of a transverse support 96 may be attached to a sliding collar 98 that fits over extension 90. The distal end of transverse support 96 may be configured for attachment to a second collar 98 on a side under ride guard 18 that extends below the opposing side edge 23 of trailer portion 12. In the embodiment of FIG. 11, collar 98 and support 96 may be positioned in a desired location along extension 90 by, for example, inserting a pin 102 through an aperture (not shown) in collar 98 for receipt in a selected aperture 100 in extension 90. Extension 90 may include a plurality of apertures 100 at spaced apart locations so that sliding collar 98 and support 96 may be placed at a variety of different locations or so that multiple collars 98 and supports 96 may be used. Alternatively, collar 98 and support 96 may be retained at any location along extension 90 by, for example, including a spring loaded pin on collar 98 that exerts a force against a surface of extension 90. When used with a trailer portion 12 that includes a dolly frame to slidably extend the rear end, collar 98 may also include an upright member that attaches to the dolly frame. Thus, as the dolly frame moves, extension 90 will be extended until the designed length of trailer portion 12 is achieved. In other embodiments, support 96 may be an angled strut (rather than transverse) similar to angled struts 80 and may be configured for removable attachment to body frame 20 in manners similar to those previously discussed.

In the embodiments illustrated, side under ride guard 18 has been described as being attached to the trailer portion 12 of a vehicle 10 that has relatively high ground clearance. Side under ride guard 18 may be provided as an attached or integral component of vehicle 10 or may be provided as a retrofit option that may be added to existing vehicles 10 with little to no alteration of the existing trailer platform. Side under ride guards 18 having extension 90 may provide particularly attractive retrofit options as the extension 90 enables a particular side under ride guard 18 to be used with several different vehicles, each of which has a different length of open space under the trailer portion. Further, in addition to obstructing progress of a passenger vehicle under side edges 23 of trailer portion 12, side under ride guard 18 may provide a framework for attaching retro-reflective tape 78 (see FIG. 1) or other lighting which may assist in making trailer portion 12 more visible to other drivers. Side under ride guard 18 also may serve as a framework to attach other devices, such as aerodynamic skirts which reduce liquid spray and increase the gas mileage for vehicle 10.

In the foregoing description, numerous details are set forth to provide an understanding of the present invention. However, it will be understood by those skilled in the art that the present invention may be practiced without these details. While the invention has been disclosed with respect to a limited number of embodiments, those skilled in the art will appreciate numerous modifications and variations therefrom. It is intended that the appended claims cover such modifications and variations as fall within the true spirit and scope of the invention.

What is claimed is:

1. A side under ride guard for a vehicle having a trailer portion having a front, a rear, and opposing side edges extending between the front and the rear, the side under ride guard comprising:
an elongate impact member configured to be positioned at a distance below the side edge of the trailer portion sufficient to obstruct progress of another vehicle under the side edge in the event of a collision; and
a plurality of support members configured to attach the elongate impact member to the trailer portion, each of the plurality of support members including an upright support and an angled support, wherein the upright supports are spaced inwardly of the elongate impact member.

2. The side under ride guard as recited in claim 1, wherein, the elongate impact member includes angularly extending opposing ends such that, when the support members are attached to the trailer portion, the angularly extending opposing ends extend inwardly towards a center of the trailer portion.

3. The side under ride guard as recited in claim 2, wherein, when the support members are attached to the trailer portion, the elongate impact member is substantially aligned with the side edge.

4. The side under ride guard as recited in claim 1, wherein the angled support is configured to absorb at least a portion of the force resulting from the collision.

5. The side under ride guard as recited in claim 4, wherein the angled support is made of a lighter gauge material than the elongate impact member.

6. The side under ride guard as recited in claim 1, comprising a plurality of angled members attached to the elongate impact element between the plurality of support members, the plurality of angled members configured to attach the elongate member to the trailer portion.

7. The side under ride guard as recited in claim 1, wherein the elongate impact member is extensible.

8. A vehicle, comprising:
a trailer portion having a front, a rear, and opposing side edges extending between the front and the rear;
a pair of side under ride guards fixedly attached to the trailer portion proximate the opposing side edges, each of the pair of side under ride guards comprising:
an elongate impact element positioned at a distance below the respective side edge of the trailer portion sufficient to block passage of another vehicle under the side edge in the event of a collision; and
a plurality of support elements that attach the elongate impact element to the trailer portion, each of the plurality of support elements including an upright support and an angled support, wherein the upright supports are spaced inwardly of the elongate impact element.

9. The vehicle as recited in claim 8, wherein the elongate impact element is substantially aligned with the side edge of the trailer portion.

10. The vehicle as recited in claim 8, wherein the trailer portion comprises a plurality of cross members extending between the opposing side edges, and wherein the plurality of support elements attach the elongate impact element to the plurality of cross members.

11. The vehicle as recited in claim 10, wherein the plurality of support elements are welded to the plurality of cross members.

12. The vehicle as recited in claim 8, wherein the angled supports are configured to absorb at least a portion of a force resulting from the collision.

13. The vehicle as recited in claim 8, wherein the elongate impact element has angularly extending opposing ends that extend under and inwardly of the side edge.

14. The vehicle as recited in claim 8, wherein the elongate impact member is extensible.

15. A method of obstructing progress of a vehicle under a side edge of a trailer portion of another vehicle, the side edge extending between a front and a rear of the trailer portion, the method comprising:
providing a side under ride guard comprising an elongate impact element and a plurality of support members attached to the elongate impact element, each of the plurality of support members including an upright support and an angled support, wherein the upright supports are spaced inwardly of the elongate impact element;
positioning the side under ride guard below the side edge of the trailer portion at a distance sufficient to obstruct progress of the vehicle under the side edge of the trailer portion in the event of a collision; and
attaching each of the support members to the trailer portion.

16. The method as recited in claim 15, comprising substantially aligning the elongate impact element with the side edge of the trailer portion.

17. The method as recited in claim 15, wherein the trailer portion includes a body frame and wherein attaching each of the support members to the trailer portion comprises welding the support members to the body frame.

18. The method as recited in claim 15, wherein the elongate impact member includes an extensible portion, and the method comprises extending the extensible portion to achieve a desired length of the elongate impact member.

19. The method as recited in claim 15, wherein the elongate impact member includes angularly extending opposing ends, and positioning the side under ride guard comprises positioning the elongate impact member such that the angularly extending opposing ends extend under and inwardly of the side edge of the trailer portion.

20. A side under ride guard for a vehicle having a trailer portion having a front, a rear, and opposing side edges extending between the front and the rear, the side under ride guard comprising:
an elongate impact member configured to be positioned at a distance below the trailer portion sufficient to obstruct progress of another vehicle under a side edge of the trailer portion in the event of a collision, the elongate impact member having angularly extending opposing ends; and
a plurality of support members configured to attach the elongate impact member to the trailer portion, wherein, when the elongate impact member is attached to the trailer portion, the angularly extending opposing ends extend under and inwardly of the side edge.

21. The side under ride guard as recited in claim 20, wherein each of the support members comprises an upright support and an angled support, and wherein the upright support is spaced inwardly of the elongate impact member.

22. The side under ride guard as recited in claim 20, wherein the elongate impact member is extensible.

23. A side under ride guard for a vehicle having a trailer portion having a front, a rear, and opposing side edges extending between the front and the rear, the side under ride guard comprising:
an elongate impact member configured to be positioned at a distance below a side edge of the trailer portion sufficient to obstruct progress of another vehicle under the side edge in the event of a collision, the elongate impact member being extensible to achieve a desired length of the elongate impact member between the front and the rear of the trailer portion; and
a plurality of support members configured to attach the elongate impact member to the trailer portion.

24. The side under ride guard as recited in claim 23, wherein each of the plurality of support members comprises an upright support and an angled support, and wherein the upright support is spaced inward of the elongate impact member.

25. The side under ride guard as recited in claim 23, wherein the elongate impact member includes angularly extending opposing ends, and wherein, when the elongate impact member is attached to the trailer portion, the angularly extending opposing ends extend under and inwardly of the side edge.
